(19) United States
(12) Patent Application Publication
(10) Pub. No.: US 2018/0026446 A1
(43) Pub. Date: Jan. 25, 2018

(54) SEAMLESS TRANSITION BETWEEN GRID CONNECTED AND ISLANDED MODES

(71) Applicant: United Technologies Corporation, Farmington, CT (US)

(72) Inventors: Francisco José González Espín, Donnybrook (IR); Virgilio Valdivia Guerrero, Roquetas de Mar (ES); Raymond Francis Foley, Carraig na bhFear (IR)

(21) Appl. No.: 15/546,684

(22) PCT Filed: Feb. 6, 2015
(86) PCT No.: PCT/US15/14787

§ 371 Date: Jul. 27, 2017

(51) Int. Cl. H02J 3/28; H02J 9/06; H02J 3/38

(52) U.S. Cl. CPC H02J 3/28; H02J 3/38; H02J 9/061; H02J 2003/388; H02J 3/387; H02J 3/30

(57) ABSTRACT

A power balancing assembly according to an exemplary aspect of the present disclosure includes, among other things, at least one sensor operable to detect a first electrical parameter and a second electrical parameter relating to a first portion of a power grid. An energy storage device is coupled to a second portion of the power grid. A controller determines that the second portion should be disconnected from the first portion based upon determining an electrical variation in the first electrical parameter, and causes the energy storage device to operate at a power level based on an instantaneous value of the second electrical parameter prior to the second portion being disconnected from the first portion of the power grid.

### BACKGROUND

This disclosure relates to power generation and consumption and, more particularly, to controlling distributed energy storage devices and loads electrically connected to a power grid.

Some power grids are electrically coupled to at least one distributed energy storage device that stores from, or provides power to, the power grid over an alternating current electrical bus. The power grid is typically coupled to a main or utility service power source that provides power to one or more loads coupled to the electrical bus. There are challenges associated with controlling power in the power grid when the utility service power source disconnects from the electrical bus.

### SUMMARY

A power balancing assembly according to an example of the present disclosure includes at least one sensor operable to detect a first electrical parameter and a second electrical parameter relating to a first portion of the power grid, and an energy storage device coupled to a second portion of the power grid. The power balancing assembly includes a controller that determines that the second portion should be disconnected from the first portion based upon determining an electrical variation in the first electrical parameter, and causes the energy storage device to operate at a power level based on an instantaneous value of the second electrical parameter prior to the second portion being disconnected from the first portion of the power grid.

In a further embodiment of any of the foregoing embodiments, the power level relates to power communicated between the first portion of the power grid and the second portion of the power grid prior to the second portion being disconnected from the first portion of the power grid.

In a further embodiment of any of the foregoing embodiments, the controller is operable to cause the energy storage device to change from a first operating state to a second operating state based upon the electrical variation.

In a further embodiment of any of the foregoing embodiments, the energy storage device includes a power converter coupled to the controller. The power converter is operable to cause the energy storage device to receive power from the power grid in the first operating state and to transmit power to the power grid in the second operating state.

In a further embodiment of any of the foregoing embodiments, the controller is operable to selectively decouple or selectively couple at least one load from the power grid in response to detecting the electrical variation.

In a further embodiment of any of the foregoing embodiments, the power level is based on power consumption of the at least one load prior to the second portion being disconnected from the first portion of the power grid.

In a further embodiment of any of the foregoing embodiments, the energy device includes at least one of a battery, a fuel cell and a flywheel.

A further embodiment of any of the foregoing embodiments includes a power generation device coupled to the second portion of the power grid. The power generation device is one of an internal combustion engine, and a turbine.

In a further embodiment of any of the foregoing embodiments, the power level of the energy storage device is set such that the power generation device provides the same amount of power before and after being disconnected from the first portion of the power grid.

In a further embodiment of any of the foregoing embodiments, the electrical variation relates to an instantaneous change in configuration of the first portion of the power grid.

In a further embodiment of any of the foregoing embodiments, the first electrical parameter is at least one of an instantaneous voltage, an instantaneous current, an instantaneous power and an instantaneous impedance on the first portion of the power grid.

A power balancing assembly according to an example of the present disclosure includes at least one sensor operable to detect a first electrical parameter of a first portion of a power grid, and a second electrical parameter of a second portion of the power grid. An energy storage device is coupled to the second portion of the power grid. The power balancing assembly includes a controller that receives information from the at least one sensor determines that the energy storage device should be disconnected from the first portion of the power grid and that at least one load should be selectively disconnected from the second portion of the power grid or selectively connected to the second portion of the power grid based upon determining an electrical variation in the first electrical parameter, and causes the energy storage device to operate at a power level after being disconnected from the first portion of the power grid. The power level is based on the second electrical parameter prior to the energy storage device being disconnected from the first portion of the power grid.

In a further embodiment of any of the foregoing embodiments, the first electrical parameter is a root-mean-square of voltage at the first portion of the power grid.

In a further embodiment of any of the foregoing embodiments, the second electrical parameter includes real and imaginary components of an instantaneous power detected at the second portion of the power grid.

In a further embodiment of any of the foregoing embodiments, the first portion of the power grid is a main grid, and the controller is operable to determine that the energy storage device should be disconnected from the main grid in response to the electrical variation.

A method of power balancing a power grid according to an example of the present disclosure includes determining that an electrical variation of a portion of a power grid meets a preselected criterion, disconnecting an energy storage device from the portion of the power grid when the electrical variation meets the preselected criterion, and causes the energy storage device to operate at a power level after being disconnected from the portion of the power grid. The power level relates to an instantaneous power at the portion of the power grid prior to the electrical variation.

A further embodiment of any of the foregoing embodiments includes causing at least one load to be selectively disconnected from the power grid or selectively connected to the power grid based upon determining the electrical variation meets the preselected criterion.

In a further embodiment of any of the foregoing embodiments, the power level is based on power consumption of the at least one load prior to disconnecting from the power grid.

A further embodiment of any of the foregoing embodiments includes communicating real and imaginary components of instantaneous power to a power converter coupled to the energy storage device.

A further embodiment of any of the foregoing embodiments includes causing the energy storage device to receive power from the power grid prior to disconnecting from the portion of the power grid and causing the energy storage device to provide power to the power grid after disconnecting from the portion of the power grid.

The various features and advantages of disclosed embodiments will become apparent to those skilled in the art from the following detailed description. The drawings that accompany the detailed description can be briefly described as follows.

### BRIEF DESCRIPTION OF THE DRAWINGS

FIG. 1 schematically illustrates an electrical grid.

FIG. 2 illustrates a method of power balancing a portion of an electrical grid.

FIG. 3A graphically illustrates a voltage profile for an electrical grid utilizing a prior art technique.

FIG. 3B graphically illustrates a voltage profile for the electrical grid of FIG. 1 implementing the method of FIG. 2.

### DETAILED DESCRIPTION

The disclosed embodiments provide the ability to balance power for a portion of an electrical grid based upon identifying an “islanding” condition in which power generation and storage equipment coupled to an electrical bus remotely located from a main grid should be disconnected from the main grid. Determining whether an islanding condition has occurred may be based on electrical parameter variations in the electrical grid. The variations in the electrical parameters are associated with changes to the electrical grid. The need to disconnect the power generation and storage equipment from the main grid becomes apparent when at least one selected criterion is met. One or more electrical parameters relating to power provided by the main grid to the electrical bus are utilized to cause the power generation and/or storage equipment to operate at a particular power level to reduce fluctuations in power on the electrical bus during a transition between grid connected and islanding conditions or modes.

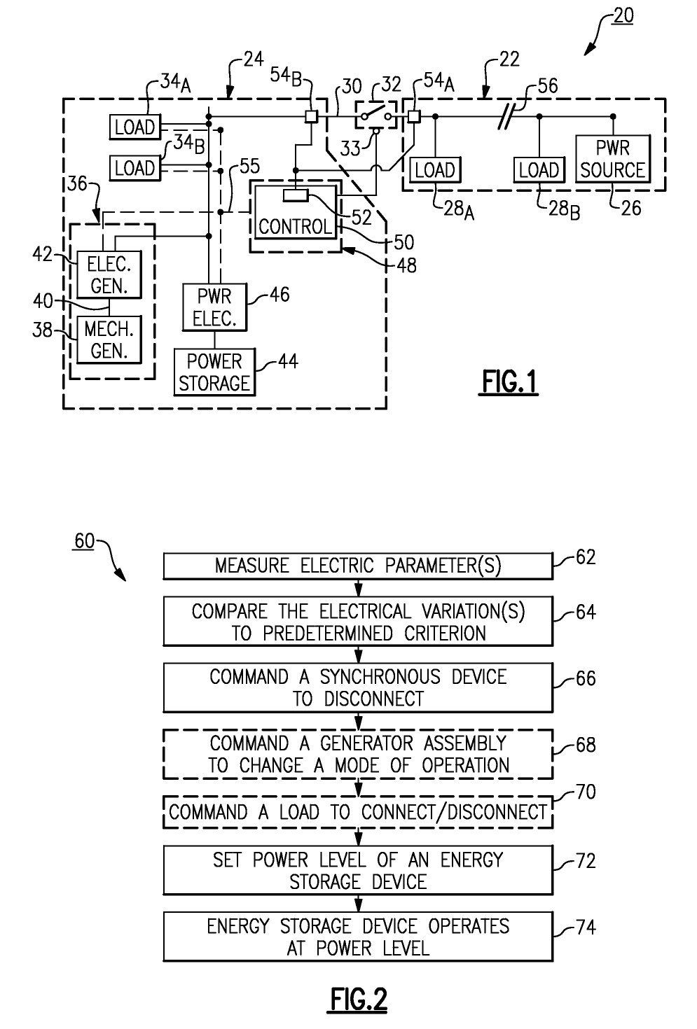

FIG. 1 schematically illustrates an electrical grid 20, including a main grid 22 and a microgrid 24, according to an embodiment. The main grid 22 has an external power source 26, provided by a main or utility power service, for example. In some embodiments, the external power source 26 is a hydroelectric or nuclear power generation source, although other power sources are contemplated with the teachings of this disclosure. The main grid 22 has one or more associated external loads 28, such as external loads 28_{A} and 28_{B}, which may be a variety of different power consumption devices such as household, industrial and commercial electrical devices. Other loads can also be coupled to the electrical grid 20, such as HVAC units and the like. In some embodiments, the microgrid 24 is coupled to other power distribution networks such as gas or water.

The microgrid 24 is electrically coupled to the main grid 22 via an electrical bus 30. In one embodiment, the electrical bus 30 is a three-phase electrical bus configured to carry alternating current (AC) between various power generation and consumption devices electrically coupled to the main grid 22 and/or the microgrid 24.

In an embodiment, the electrical bus 30 is electrically coupled to the main grid 22 by at least one synchronous device 32 such as a circuit breaker, for example. The synchronous device 32 is operable to selectively disconnect or electrically isolate the microgrid 24 from the main grid 22 in response to or based upon receiving one or more commands at a signal interface 33.

The microgrid 24 includes one or more local load devices 34 such as loads 34_{A}, 34_{B} operable to consume power provided on the electrical bus 30. The local load devices 34 include commercial and/or industrial equipment situated in a building, for example. In other embodiments, the load devices 34 include various energy storage devices, including any of the storage devices discussed in this disclosure.

In some embodiments, the microgrid 24 includes at least one generator assembly 36 electrically coupled to the electrical bus 30 to provide power for consumption by the local load devices 34 and/or the external loads 28. In an embodiment, the generator assembly 36 includes a mechanical power generation device 38 such as a combustion engine mechanically coupled to an electrical generator 42 by an output shaft 40. The electrical generator 42 is operable to convert mechanical energy provided by the mechanical power generation device 38 via the output shaft 40 into electrical energy to be provided on a power supply line coupled to the electrical bus 30. Other power generation devices are contemplated with the teachings of this disclosure, including wind turbines, hydro turbines, fuel cells, and any of the power storage devices discussed in this disclosure.

The microgrid 24 includes one or more bidirectional energy storage devices 44 coupled to the electrical bus 30, which in some embodiments operate in parallel with the at least one generator assembly 36 to selectively store energy from the main grid 22 and/or microgrid 24 and provide power and energy to the local load devices 34 and/or the external loads 28. The energy storage devices 44 are operable to selectively store energy provided by the generator assembly 36 and/or the external power source 26 or other power sources coupled to the electrical grid 20. Various energy storage devices 44 are contemplated, including one or more batteries, fuel cells, and flywheels, for example. Other alternating current (AC) and direct current (DC) energy storage devices 44 such as large capacity solid state devices or capacitors, such as ultra-capacitors and the like, are also contemplated. Any device that interfaces with a power grid utilizing power electronics may benefit from the teachings herein, including microgrid system-level controllers and any of the power generation devices discussed in this disclosure.

In some embodiments, the energy storage device 44 is coupled to the electrical bus 30 by one or more power electronics devices 46 such as a power converter or inverter. The power electronics device 46 is operable to set, control, or otherwise affect a power level of the energy storage device 44. Setting the power level above or below a predetermined threshold or range causes the energy storage device 44 to either receive or otherwise consume power from the power grid 20 in a first operating state and transmit or otherwise provide power to the power grid 20 in a second operating state. In an embodiment, the power electronics device 46 is operable to communicate real and/or imaginary power between the energy storage devices 44 and the power grid 20.

A control assembly 48 is electrically coupled to the various components of the main grid 22 and/or microgrid 24. The example control assembly 48 is configured to provide or determine various measurements, computations and/or control functions utilizing at least one controller 50. The controller 50 is a single board processor or another logic device, for example, and includes a sensor interface 52 for electrical communication with one or more sensors 54.

The sensors 54 are positioned at any number of locations in the electrical grid 20 such as sensors 54_{A} and 54_{B}. In one embodiment, sensor 54_{A} is operable to measure at least one electrical parameter of a portion of the power grid 20, including a power supply line such as each line of the electrical bus 30. In some embodiments, sensor 54_{A} is operable to measure at least one of an instantaneous voltage (measured in volts), an instantaneous current (measured in amperes), and an instantaneous power. In some embodiments, the electrical parameter(s) measured by the sensor 54_{A} and analyzed by the control assembly 48 include real and/or imaginary components.

In some embodiments, sensor 54_{B} is a power meter operable to detect or measure other electrical parameter(s) of the electrical grid 20, such as the instantaneous values of power on the electrical bus 30, which may include real and/or imaginary components. It should be appreciated that other sensors can be coupled to the sensor interface 52 for detecting various characteristics of the main grid 22 and/or the microgrid 24, and the individual components thereof.

The control assembly 48 is electrically coupled to the various power generation, storage and/or consumption devices and other electrical components of the microgrid 24 by one or more signal lines 55 (shown in dashed lines). Various signals on the signal lines 55 are contemplated, including analog or digital signals utilizing one or more communications protocols, for example. In this manner, the control assembly 48 is operable to set, control or otherwise affect various operating characteristics of the power generation, storage and/or consumption devices and other electrical components of the electrical grid 20 based on information communicated on the signal lines 55.

Under some conditions a grid fault or change in a configuration of the electrical grid 20 can occur, such as at location 56, which may adversely affect normal operations of portions of the main grid 22 and/or the microgrid 24. In some instances, a grid fault at location 56 results in the generator assembly 36 and/or the energy storage device 44 continuing to provide power to at least one of the external loads 28, such as external load 28_{A}. This condition may be referred to as “islanding” or an “islanding condition.” In some operating environments, the microgrid 24 must disconnect from the main grid 22 within a predetermined period of time during islanding conditions. For instance, Institute of Electrical and Electronics Engineers (IEEE) 1547

“Standard for Interconnecting Distributed Resources with Electric Power Systems” specifies that a microgrid shall disconnect from a main grid within approximately two seconds to reduce the likelihood that power is provided to external loads while a main grid is being serviced or repaired.

The controller 50 is operable to determine that a portion of the power grid 20, such as microgrid 24 or electrical bus 30, should be disconnected from the main grid 22 in response to, or otherwise based upon, detecting an islanding condition. The controller 50 is also operable to cause the energy storage device 44 to operate at a first power level in a grid connected condition and at a second power level in the islanding condition such that the power consumed and generated in the microgrid 24 is substantially balanced during a transition between the two conditions.

FIG. 2 illustrates a method in a flowchart 60 of balancing power on an electrical bus in response to or based upon detecting a grid condition that may involve or lead to islanding, such as the grid fault at location 56 shown in FIG. 1. A grid condition can be a situation where an islanding condition occurs, as previously discussed.

At 62 the sensors 54 positioned at 54_{A} and 54_{B}, for example, measure the instantaneous values of one or more electrical parameters on the electrical bus 30. One of the electrical parameters is at least one of an instantaneous voltage, instantaneous current, an instantaneous power and/or impedance on the electrical bus 30 at the location of sensor 54_{A}, for example. In one embodiment, sensor 54_{A} measures the instantaneous values of the three phase voltages carried on the electrical bus 30 during grid connected and islanding conditions. Another one of the electrical parameters is an instantaneous power on the electrical bus 30 at the location of sensor 54_{B}, for example. In other embodiments, the electrical parameter(s) are measured over a period of time. In some embodiments, measurement of the electrical parameter(s) occurs during the same time instance, cycle and/or period of time. In alternative embodiments, the values of the electrical parameter(s) are measured by another device coupled to the electrical bus 30.

At 64 the controller 50 determines whether an islanding condition has occurred by comparing electrical variations relating to the electrical parameter(s) to at least one predetermined criterion or threshold. In some embodiments, the predetermined criterion corresponds to a threshold or range corresponding to the electrical parameter(s) under expected or observed operating conditions. The expected or observed operating conditions may be determined through simulation, experimentation, or observation of the various components of the power grid 20. The predetermined criterion is set or determined and provided to the controller 50 at installation, for example. Each predetermined criterion can be set or adjusted depending on the needs of a particular situation. In alternative embodiments, the controller 50 is configured to receive one or more signals from another device that detects an islanding condition or grid event in the electrical grid 20.

At 66 the controller 50 commands at least the synchronous device 32 to disconnect the electrical bus 30 or microgrid 24 from the main grid 22 when the controller 50 determines that the electrical variation(s) meets the at least one predetermined criterion. In this state, the devices comprising the microgrid 24 are protected from anomalies or transients caused by the grid fault. In an embodiment, the control assembly 48 communicates or broadcasts the detection of a grid condition to various equipment or devices associated with the electrical grid 20.

Various techniques for evaluating the electrical variations are contemplated. In one embodiment, the controller 50 compares the true root mean square (RMS) voltage of the electrical parameter(s) utilizing various data or information from sensor 54_{A}. In another embodiment, the controller 50 compares a magnitude of the electrical parameter(s) to one or more predetermined thresholds or ranges, for example. The magnitude may correspond to the instantaneous values of one or more of the three-phase waveforms carried on the electrical bus 30, such as voltage, for example. In other embodiments, the controller 50 compares an average of the electrical variations over a period of time to one or more predetermined criterion.

In some embodiments, the controller 50 determines electrical variation at a particular frequency, range of frequencies, and/or any harmonics of the frequency. These harmonics include multiples of the frequency or frequencies of the electrical parameter(s) and any arithmetic combinations thereof, which may relate to the fundamental frequency of the electrical grid 20. In some examples, the harmonics of the frequency is determined by evaluating the electrical parameter(s) with a Fourier transform such as the Fast Fourier Transform (FFT). Considering the harmonics of the frequency can provide additional accuracy in determining whether the electrical variations are related to a grid fault rather than some other condition such as various operating characteristics of power electrics devices connected to the electrical bus 30.

Various filtering techniques for detecting the electrical variations are contemplated, including low-pass filters, high-pass filters, band-pass filters, and any combination thereof, such as cascading two or more band-pass filters. Other techniques for filtering each electrical parameter may include utilizing various Fourier transforms such as Discrete Fourier Transform (DFT) at a frequency of interest.

In some embodiments, the controller 50 is configured to cause other devices coupled to the electrical grid 20 to change a mode of operation or operating characteristic in response to, or otherwise based upon, determining that an islanding condition or other grid condition has occurred. In one embodiment, the controller 50 is configured to command the generator assembly 36 to disconnect from the electrical grid 20 or adjust the power output characteristics of the generator assembly 36. In some embodiments, the control assembly 48 is configured to cause one or more generator assemblies 36 or energy storage devices 44 to change its local control structure from a real and imaginary (P, Q) power source to a voltage source to balance at least a portion of the power in the microgrid 24 after a grid condition has been detected. In another embodiment, the controller 50 is configured to command one or more loads 34 to selectively decouple or disconnect from the power grid 20 in response to or based upon detecting the grid event at 70. This technique, sometimes referred to as “load shedding,” may be utilized to improve power balancing by reducing power generation requirements for other loads connected to the microgrid 24. In some embodiments, the load shedding technique includes selectively disconnecting and/or connecting one or more loads 34 to improve power balancing.

The controller 50 is configured to calculate or otherwise determine the total amount of power to be balanced in the microgrid 24, which includes the power levels of the microgrid 24 and the main grid 22 before the grid event. The power level of the microgrid 24 includes the power of controllable devices, such as load(s) that can be shed (or connected) and energy storage device(s) which are controlled to account for power differences due to portions of the main grid 22 disconnecting from the microgrid 24, as well as any devices other that may not be controlled by the controller 50. At 72 the controller 50 sets or otherwise affects a power level of the energy storage device(s) 44 based on the electrical variations, and in some situations causes the power level to increase or decrease. In one embodiment, the power level is based on the electrical parameter corresponding to the power on the electrical bus 30 prior to an islanding condition being detected. The controller 50 communicates the electrical parameter(s) to the energy storage device(s) 44, such as one or more power set points which relate to power provided by or to the main grid 22 before disconnecting from the microgrid 24. The power set points are based on the power measured at sensor 54_{B} prior to disconnection, and can be adjusted to account for any load shedding (or connecting) of loads to the electrical bus 30. In some embodiments, the power level is based on power on the main grid 22 at a single cycle or average of cycles prior to disconnecting from the microgrid 24 or electrical bus 30. In some embodiments, the controller 50 continuously adjusts or refines the power level of the energy storage device(s) 44 over a period of time, although measuring each electrical parameter at 62 may occur instantaneously such as within a single cycle of each electrical parameter. In one embodiment, the power measurements are stored in one or more memory locations accessible by the controller 50. In this embodiment, the last electrical parameter measured by sensor 54_{B} and stored in memory is utilized for power balancing by affecting the power level or set points of the energy storage device(s) 44 and/or load shedding, for example. In another embodiment, the controller 50 causes the power level of the energy storage device(s) 44 to increase or decrease based upon the combination of a load shedding technique as previously discussed.

Various signals are contemplated, including digital and analog techniques. In some embodiments, the control assembly 48 communicates one or more signals to a power electronics device coupled to the energy storage device 44. In one embodiment, the control assembly 48 communicates a real component and an imaginary component of the power as two different signals. In another embodiment, the control assembly 48 communicates a real or imaginary component of the power as one signal and a power factor as another signal. In an embodiment, the control assembly 48 communicates one of the real and imaginary components of the power.

Various techniques for setting or otherwise determining the power level are contemplated. In some embodiments, the power level of each energy storage device 44 is based on storage capacity, discharge rate, current energy storage level, or some other characteristic or condition of each energy storage device 44 coupled to the microgrid 24 or electrical bus 30. In one embodiment, the power provided by the main grid 22 prior to the islanding condition is allocated between two or more energy storage devices 44 coupled to the microgrid 24. In some embodiments, the power level is based at least in part on the power consumption of the one or more loads 34 selectively disconnected (or connected) from the power grid 20 in response to or based upon detecting the islanding condition. In some embodiments, the power level is set such that the power output of the power generation device(s) 36 remains the same or substantially the same before and after a grid event has been detected.

At 74 the energy storage device(s) 46 operates at the power level. In some instances, a change from the previous power level may cause the energy storage device(s) 46 to change between a first operating mode and a second operating mode, such as between energy storage and energy dissipation or generation. In some embodiments, the power levels of two or more energy storage devices 44 are set such that the energy storage devices 44 operate in different operating modes during the islanding condition to provide the desired solution.

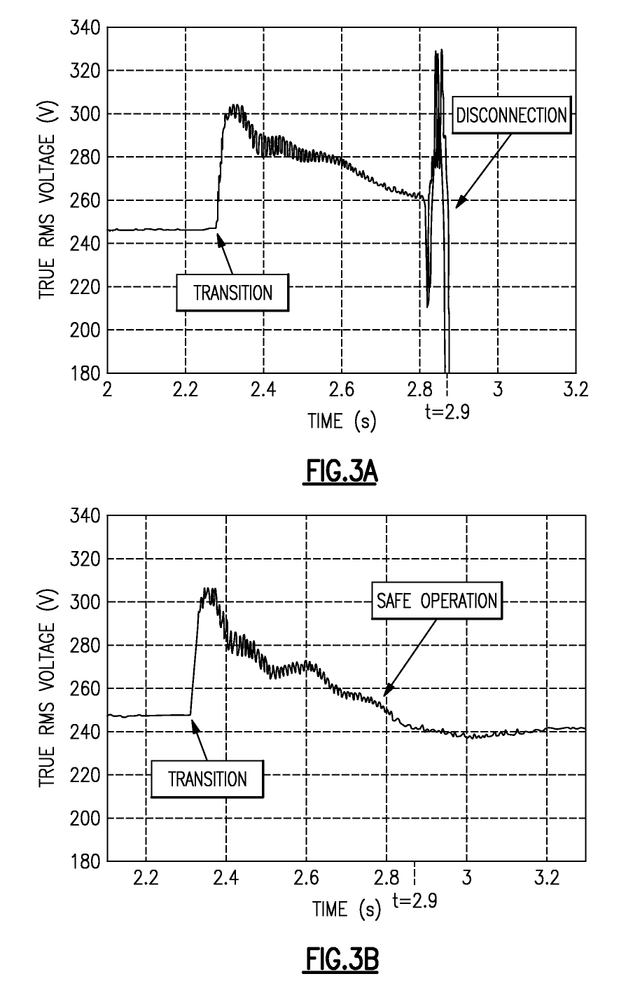

FIGS. 3A and 3B illustrate a prior art method (FIG. 3A) and the example method 60 (FIG. 3B) where the electrical parameter of interest is true RMS voltage on an electrical bus. Prior art method utilizes reconfiguration of a rotating machine governor coupled to a generator unit and an automatic voltage regulator (AVR), in which the generator unit is configured to change its local control structure from a real and imaginary (P, Q) power source to a voltage source to balance power in a microgrid. At approximately t=2.9 seconds the voltage on the grid spikes due to voltage remaining outside of a predetermined safety region or margin for too long which in the illustrated example is caused by a grid event occurring at t=2.3 seconds, causing a protection mechanism to trip, thereby disconnecting the generator unit from the microgrid. The prior method may result in power loss or disruption to one or more loads in the microgrid. As shown in FIG. 3B, however, the example method 60 reduces the likelihood of the voltage remaining outside predetermined safety region or threshold for too long, by utilizing the power balancing techniques discussed in this disclosure. Accordingly, the likelihood of power generation devices and loads utilizing protection mechanisms disconnecting from the microgrid is reduced.

The controller 50 typically includes a processor, a memory and an interface. The processor may, for example only, be any type of known microprocessor having desired performance characteristics. The memory may, for example only, includes UVPROM, EEPROM, FLASH, RAM, ROM, DVD, CD, a hard drive, or other computer readable medium which may store data and the method 60 for operation of the controller 50 of this description. The interface facilitates communication, through digital, analog or any communications protocol, with the other systems or components comprising the electrical grid 20. In some examples, the controller 50 may be a portion of the energy storage device 44 or power electronics devices 46, another system, or a stand-alone system.

Even though voltage is provided as an example electrical parameter for determining electrical variations in this description, it should be appreciated that current, power, grid impedance, frequency and/or other electrical characteristics can be considered in executing the method 60 disclosed herein. In other embodiments, the electrical parameter is at least one of an instantaneous voltage, an instantaneous current, an instantaneous power, an instantaneous frequency and an instantaneous impedance on a portion of the power grid. Also, even though the method 60 is described in terms of the controller 50, it should be appreciated that another device such as a stand-alone device can be programmed to execute any of the techniques described herein.

Although the different examples have a specific component shown in the illustrations, embodiments of this disclosure are not limited to those particular combinations. It is possible to use some of the components or features from one of the examples in combination with features or components from another one of the examples. It should also be understood that any particular quantities disclosed in the examples herein are provided for illustrative purposes only.

Furthermore, the foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

We claim:

1. A power balancing assembly, comprising:
at least one sensor operable to detect a first electrical parameter and a second electrical parameter relating to a first portion of a power grid;
an energy storage device coupled to a second portion of the power grid; and
a controller that:
determines that the second portion should be disconnected from the first portion based upon determining an electrical variation in the first electrical parameter, and
causes the energy storage device to operate at a power level based on an instantaneous value of the second electrical parameter prior to the second portion being disconnected from the first portion of the power grid.

2. The assembly as recited in claim 1, wherein the power level relates to power communicated between the first portion of the power grid and the second portion of the power grid prior to the second portion being disconnected from the first portion of the power grid.

3. The assembly as recited in claim 1, wherein the controller is operable to cause the energy storage device to change from a first operating state to a second operating state based upon the electrical variation.

4. The assembly as recited in claim 3, wherein the energy storage device includes a power converter coupled to the controller, the power converter operable to cause the energy storage device to receive power from the power grid in the first operating state and to transmit power to the power grid in the second operating state.

5. The assembly as recited in claim 1, wherein the controller is operable to selectively decouple or selectively couple at least one load from the power grid in response to detecting the electrical variation.

6. The assembly as recited in claim 5, wherein the power level is based on power consumption of the at least one load prior to the second portion being disconnected from the first portion of the power grid.

7. The assembly as recited in claim 1, wherein the energy device includes at least one of a battery, a fuel cell and a flywheel.

8. The assembly as recited in claim 1, comprising a power generation device coupled to the second portion of the power grid, wherein the power generation device is one of an internal combustion engine, and a turbine.

9. The assembly as recited in claim 8, wherein the power level of the energy storage device is set such that the power generation device provides the same amount of power before and after being disconnected from the first portion of the power grid.

10. The assembly as recited in claim 1, wherein the electrical variation relates to an instantaneous change in configuration of the first portion of the power grid.

11. The assembly as recited in claim 1, wherein the first electrical parameter is at least one of an instantaneous voltage, an instantaneous current, an instantaneous power and an instantaneous impedance on the first portion of the power grid.

12. A power balancing assembly, comprising:
at least one sensor operable to detect a first electrical parameter of a first portion of a power grid and a second electrical parameter of a second portion of the power grid;
an energy storage device coupled to the second portion of the power grid; and
a controller that:
receives information from the at least one sensor,
determines that the energy storage device should be disconnected from the first portion of the power grid and that at least one load should be selectively disconnected from the second portion of the power grid or selectively connected to the second portion of the power grid based upon determining an electrical variation in the first electrical parameter, and
causes the energy storage device to operate at a power level after being disconnected from the first portion of the power grid, the power level being based on the second electrical parameter prior to the energy storage device being disconnected from the first portion of the power grid.

13. The assembly as recited in claim 12, wherein the first electrical parameter is a root-mean-square of voltage at the first portion of the power grid.

14. The assembly as recited in claim 12, wherein the second electrical parameter includes real and imaginary components of an instantaneous power detected at the second portion of the power grid.

15. The assembly as recited in claim 12, wherein the first portion of the power grid is a main grid, and the controller is operable to determine that the energy storage device should be disconnected from the main grid in response to the electrical variation.

16. A method of power balancing a power grid, comprising:
determining that an electrical variation of a portion of a power grid meets a preselected criterion;
disconnecting an energy storage device from the portion of the power grid when the electrical variation meets the preselected criterion; and
causing the energy storage device to operate at a power level after being disconnected from the portion of the power grid, the power level relating to an instantaneous power at the portion of the power grid prior to the electrical variation.

17. The method as recited in claim 16, comprising causing at least one load to be selectively disconnected from the power grid or selectively connected to the power grid based upon determining the electrical variation meets the preselected criterion.

18. The method as recited in claim 17, wherein the power level is based on power consumption of the at least one load prior to disconnecting from the power grid.

19. The method as recited in claim 16, comprising communicating real and imaginary components of instantaneous power to a power converter coupled to the energy storage device.

20. The method as recited in claim 16, comprising causing the energy storage device to receive power from the power grid prior to disconnecting from the portion of the power grid and causing the energy storage device to provide power to the power grid after disconnecting from the portion of the power grid.
